(19) United States
(12) Patent Application Publication
(10) Pub. No.: US 2014/0079350 A1
(43) Pub. Date: Mar. 20, 2014

(54) BEARING WITH AN ENERGY PRODUCTION UNIT, IN PARTICULAR SELF-ALIGNING ROLLER BEARING FOR THE MOUNTING OF A ROLLER

(71) Applicants: Thomas Rink, Waldfenster (DE); Werner Roman, Kressberg (DE); Heinz Theumer, Niederwerrn (DE); Martin Grehn, Dittelbrunn (DE); Henri van der Knokke, Buchs (CH); Karl Muller, Grettstadt (DE)

(72) Inventors: Thomas Rink, Waldfenster (DE); Werner Roman, Kressberg (DE); Heinz Theumer, Niederwerrn (DE); Martin Grehn, Dittelbrunn (DE); Henri van der Knokke, Buchs (CH); Karl Muller, Grettstadt (DE)

(73) Assignee: Schaeffler Technologies AG & Co. KG, Herzogenaurach (DE)

(21) Appl. No.: 14/116,629

(22) PCT Filed: Apr. 17, 2012
(86) PCT No.: PCT/EP2012/056953

§ 371 Date: Nov. 8, 2013

(30) Foreign Application Priority Data
May 10, 2011 (DE) 10 2011 075 548.9

(51) Int. Cl. F16C 23/08

(52) U.S. Cl. CPC F16C 23/086
USPC 384/497

(57) ABSTRACT

A bearing, in particular rolling contact bearing (1), having a first bearing ring (2), a second bearing ring (3) and an energy production unit (8) designed as a claw pole generator, wherein the claw pole generator (8) includes a first claw ring (10) with a sequence of first claws (11) and a second claw ring (12) which is offset in the revolving direction of the axis of rotation (6) and has a sequence of second claws, wherein the two claw rings (10, 12) surround an induction coil (9) encircling the axis of rotation (6), wherein the claws (11) of the two claw rings (10, 12) together with a sequence of magnetic poles (14) encircling the axis of rotation (6) form magnetic circuits surrounding the induction coil (9). The objective of providing a bearing which permits retrofitting with a claw pole generator is solved according to the invention in that the claw rings (10, 12) and the induction coil (9) are fastened by a first support ring (24; 24′) on an end surface (16) of the first bearing ring (2), in that the magnetic poles (14) are fastened on the end surface (20) of the second bearing ring (3) by a second support ring (18), wherein the magnetic poles (14) are connected in a magnetically conductive manner to one another by a return-path ring made from a magnetically conductive material, and wherein the two claw rings (10, 12) are connected in a magnetically conductive manner by a flux-conducting ring (17).

### BACKGROUND

The invention relates to a bearing and to a bearing arrangement for rotatably mounting a roller, in particular a guide roller for paper webs.

It is known from practice to generate electrical energy during operation from the rotary movement of a bearing, in particular a rolling or plain bearing. For this purpose, in particular rolling bearings are known in which an energy generation unit is structurally integrated. Specifically, rolling bearings are known in which the energy generation unit is in the form of a claw-pole generator. Here, the claw-pole generator comprises a first claw ring with a series of first claws which runs in the circumferential direction of the rolling bearing, a second claw ring with a series of second claws which runs in the circumferential direction of the rolling bearing, an induction coil which is surrounded by the two claw rings and which encircles the axis of rotation of the rolling bearing, wherein the two claw rings are arranged offset with respect to one another in the circumferential direction. The claw-pole generator further comprises a series of magnetic poles which runs in the circumferential direction. If a first claw of the first claw ring is opposite a first pole, for example a north pole, a magnetic circuit is formed via a second claw, which is adjacent in the circumferential direction, namely a claw of the second claw ring with respect to a second magnetic pole of different polarity, in this case a south pole, which is adjacent in the circumferential direction and which surrounds the induction coil. If the bearing ring with the two claw rings rotates further, the second claw is opposite the north pole and the first claw is opposite a south pole, with the result that the direction of the magnetic circuit surrounding the induction coil is reversed and a magnetic potential is generated in the induction coil. Integrated in a rolling bearing, the two claw rings and the induction coil are fastened on one of the two bearing rings of the rolling bearing.

On rolling bearings with an energy generation unit, in particular on rolling bearings with a claw-pole generator, it is known from experience that it is necessary to provide only a small additional installation space for the claw-pole generator or to use existing installation space, so that the rolling bearing with the claw-pole generator deviates as little as possible from standard dimensions.

Bearing types such as self-aligning roller bearings or spherical plain bearings which, in addition to a rotary movement, also enable tilting of the two bearing rings of the bearing in relation to one another, are also known from practice. With such tilting, the claw of one of the claw rings is inclined with respect to the associated magnetic pole, with the result that the gap between the claw and the magnetic pole over which the magnetic circuit is intended to be closed is substantially widened and the magnetic circuit is closed only incompletely. Until now, claw-pole generators have therefore been less suitable for bearing types such as self-aligning roller bearings or spherical plain bearings or more generally for bearings which, in addition to a rotation, are also intended to enable tilting of the two bearing rings, for energy generation.

WO 2011/000362 A1 describes a rolling bearing in the form of a single-row ball bearing comprising two bearing rings, a plurality of rolling elements which are guided by a bearing cage, and an energy generation unit in the form of a claw-pole generator, wherein the claw-pole generator has a first claw ring with a series of first claws and a second claw ring with a series of second claws which is offset in the circumferential direction of the bearing ring, wherein the two claw rings surround an induction coil encircling in the circumferential direction of the first bearing ring, wherein the claws of the two claw rings with a series of magnetic poles encircling in the circumferential direction form magnetic circuits surrounding the induction coil. The two claw rings are in this case fastened on an inner lateral surface of the first bearing ring in magnetically conductive connection, and the magnetic poles are arranged on an inner lateral surface of the second bearing ring of the rolling bearing, so that the magnetic circuit surrounding the induction coil is closed by a magnetically conductive section of the first bearing ring. The claw rings and the induction coil in this case take up installation space in the region between the two bearing rings. Further, retrofittiing of bearings which are already fitted in an operating position is complex and is not possible without dismantling of the bearing.

U.S. Pat. No. 6,838,794 B2 describes a bearing, in particular a rolling bearing, with a first bearing ring, a second bearing ring and an energy generation unit which is configured as a claw-pole generator. The claw-pole generator comprises a first claw ring fastened on a first bearing ring and having a series of first claws encircling along a circumference of the first bearing ring, a second claw ring which is fastened on the first bearing ring and has a series of second claws encircling along the circumference of the first bearing ring, and a magnetic induction coil arranged between the two claw rings. Further, the bearing comprises a series of magnetic poles in the form of a magnet ring and encircling along a circumference of the second bearing ring and a magnetic induction coil arranged between the two claw rings, wherein a closed magnetic circuit encircling the induction coil is closed from a first magnetic pole of the magnet ring via a first claw of the first claw ring and via a second claw of the second claw ring to the second magnetic pole of the magnetic ring which has a different polarity than the first magnetic pole. The induction coil is arranged in a receptacle which is U-shaped in cross section, wherein the limbs of the U are formed by the two claw rings, and wherein the two claw rings are magnetically conductively connected to one another by the base of the U, with the result that the magnetic flux is passed through the first claw in the first limb of the U, then through the base of the U and thereafter through a second claw in the second limb of the U. The base of the U bears against the first bearing ring and reduces the installation space between the two bearing rings which is available for receiving a maximum number of turns of the induction coil. As a measure for increasing the number of turns of the induction coil, the invention proposes providing in each case one cutout in the lateral surfaces of the two opposite bearing rings and arranging the induction coil and the series of magnetic poles in the respective cutout. For this purpose, structural changes to the two lateral surfaces of the two bearing rings are required; in particular the two bearing rings are extended in the direction of the axis of rotation such that the race is arranged in the first half of the axial extent and the claw-pole generator is arranged in the other half of the axial extent. In this case, too, retrofittiing of a bearing located in the fitted position with a claw-pole generator is not possible without the bearing being completely replaced.

U.S. 2005/0174011 A1 describes a bearing in the form of a rolling bearing, namely an angular contact ball bearing, with a claw-pole generator, wherein the series of magnetic poles in the form of an encircling magnet ring is arranged in a cutout in the second bearing ring, and the induction coil, surrounded in cross section on all sides by the lamination blanks of the two claw rings, rests sectionally on an end face of the first bearing ring and in this case is also arranged sectionally in a cutout arranged in the lateral surface of the first bearing ring. The series of magnetic poles is arranged on an inner lateral surface. For receiving the induction coil or the magnetic poles, at least one of the bearing rings is extended in the direction of the axis of rotation and the other of the bearing rings is provided with a cutout.

### SUMMARY

The object of the invention is to provide a bearing which enables retrofittiing with a claw-pole generator.

This object is achieved according to the invention for the bearing mentioned at the outset in that the claw rings and the induction coil are fastened with a first carrier ring on an end face of the first bearing ring, in that the magnetic poles are fastened on the end face of the second bearing ring by means of a second carrier ring, wherein the magnetic poles are magnetically conductively connected to one another by means of a magnetic return path ring formed of a magnetically conductive material, and

wherein the two claw rings are magnetically conductively connected by means of a flux-concentrating ring.

The first carrier ring with the two claw rings and the induction coil forms a first structural unit, which can be fitted retrospectively on the end face of a bearing which is already in the operating position. Further, the second carrier ring with the magnetic poles forms a second structural unit which can be attached retrospectively to the end face of the second bearing ring which is likewise in the operating position, if appropriate. The flux-concentrating ring which magnetically conductively connects the two claw rings ensures that, via the first bearing ring, in any case only leakage fluxes contribute to closing of the magnetic circuit around the induction coil. The magnetic return path ring which magnetically conductively connects the magnetic poles to one another also ensures that the magnetic circuit between magnetic poles of different polarity which are adjacent to one another in the circumferential direction is closed.

The two structural units can be produced separately and only connected during fitting to form the claw-pole generator. In this case, the bearing maintains its standardized dimensions, wherein the two flat carrier rings only make a small amount of installation space in the direction of the axis of rotation of the bearing necessary.

Preferably, provision is made for a gap to be formed between the claws and the magnetic poles, said gap being inclined towards the axis of rotation. In a section plane which contains the axis of rotation, the gap does not run substantially parallel to the axis of rotation but forms, at least as an imaginary extension of the section contour of the gap, an angle with the axis of rotation. In this case, the gap does not surround the axis of rotation substantially cylindrically, but provision is made for the gap to be delimited by at least one noncylindrical face. The at least one noncylindrical face can be configured such that the area of the face via which the magnetic circuit is closed is enlarged, with the result that, on the relative rotation of the two bearing rings, a considerable change in the encircling direction of the magnetic circuit around the induction coil and therefore a particularly high induced voltage in the turns of the electrical conductor of the induction coil is induced.

Preferably, in respect of the gap, provision is made for the gap, which is inclined with respect to the axis of rotation, to have a substantially linear profile. In particular, provision is made for the gap to have, by way of delimitation, noncylindrical faces, in particular in respect of possible tilting of the two bearing rings with respect to one another, wherein, for example, one of the faces delimiting the gap is formed as an imaginary extension of a race of one of the bearing rings. During tilting of the bearing rings with respect to one another, the width of the gap remains approximately constant along its extent, in particular when the other face which likewise delimits the gap is formed parallel to the first as an imaginary extension of the race of one of the two bearing rings.

In particular, provision can preferably be made for the gap to be substantially delimited by at least one conically tapering face, in particular by two conically tapering faces.

As an alternative to at least one conically tapering face delimiting the gap and as an alternative to a gap with a substantially linear profile, provision can preferably be made for the gap to have a curved profile, in particular a profile which is curved substantially in the form of a segment of a circle. In a section plane containing the axis of rotation, the gap has a curved profile, in particular a profile which is sectionally in the form of a segment of a circle, wherein a radius of curvature of the circle segment of the gap profile in the section plane can correspond to a radius of curvature of the race of the bearing ring. In this case, provision can be made for the gap to be delimited substantially by at least one face which is curved spherically sectionally, in particular by two spherically curved faces.

A claw-pole generator with a noncylindrical face delimiting a gap between the claw and the magnetic pole is in particular preferably provided for the case where the bearing is in the form of a self-aligning roller bearing or a spherical plain bearing, i.e. tilting of the two bearing rings with respect to one another is intended to be provided. It goes without saying that other types of bearing which enable tilting of the bearing rings with respect to one another in addition to the rotation of the two bearing rings relative to one another can also be provided and can be equipped with such a claw-pole generator.

Provision is preferably made for the magnetic return path ring to be formed integrally with the second carrier ring, in particular for the second carrier ring to be formed from a magnetically conductive material. In this case, the magnetic return path ring is formed as a magnetically conductive section of the second carrier ring. As an alternative to this, provision can be made for the magnetic return path ring to be in the form of a component part which is fastened to the second carrier ring and which is independent of the second carrier ring, in particular when the magnetic conductivity of the second carrier ring is low or when the second carrier ring has a geometry which is unfavorable for a magnetically conductive connection of the magnetic poles.

Preferably, provision is made for an extent of the magnetic poles in the axial direction to be greater than the extent of the claws in the axial direction, in particular for the extent of the magnetic poles in the axial direction to be approximately double the extent of the claws in the axial direction. The magnetic poles in this case protrude beyond the claws in the axial direction, parallel to the axis of rotation of the bearing, so that shifts of the bearing in the axial direction or slight tilting of the two bearing rings relative to one another barely interrupts the magnetic flux which bridges the gap between the claw and the magnetic pole.

Provision is preferably made for the flux-concentrating ring to be formed integrally with the first carrier ring, in particular for the first carrier ring to be formed from a magnetically conductive material. The flux-concentrating ring is in the form of a magnetically conductive section of the first carrier ring, with the result that the magnetic circuit between the two claw rings is closed via the first carrier ring; leakage fluxes through the first bearing ring only contribute very little to the magnetic circuit and are suppressed in terms of their effect on the AC voltage generated in the induction coil. Alternatively, provision can be made for the flux-concentrating ring to be in the form of a component part which is fixed on the first carrier ring and is independent of the first carrier ring.

Provision is preferably made for at least one of the carrier rings to be fastened on the end face of the bearing ring by a screw connection. In particular both carrier rings can be attached to the bearing rings of the bearing which are already located in the fitted position retrospectively using a simple screw connection and, if necessary, removed again. The claw-pole generator can therefore be arranged temporarily on the bearing, for example for measurement purposes in order to supply energy to a sensor. In particular, the AC voltage generated in the claw-pole generator in the induction coil, for example the amplitude and/or frequency thereof, can be part of a measured variable which is detected by the sensor.

A preferred application of a bearing with a claw-pole generator can in particular be considered to be a bearing arrangement for rotatably mounting a guide roller for paper webs. In particular, provision is made for a pressure sensor, in particular a piezoelectric pressure sensor, to be arranged on the lateral surface of the roller, wherein energy is supplied to the pressure sensor by the energy generation unit of the bearing, in particular the self-aligning roller bearing.

Further advantages and features result from the dependent claims and the description below relating to two preferred exemplary embodiments of the invention.

### BRIEF DESCRIPTION OF THE DRAWINGS

The invention will be described in more detail and explained below with reference to the attached drawings.

FIG. 1 shows a partially sectioned view of a first exemplary embodiment of a bearing according to the invention in a partially sectioned view of a bearing arrangement according to the invention,

FIG. 2 shows the detail ‘Z’ from FIG. 1 in an enlarged illustration, and

FIG. 3 shows, sectionally, a partially sectioned view of a second exemplary embodiment of a bearing according to the invention.

### DETAILED DESCRIPTION OF THE PREFERRED EMBODIMENTS

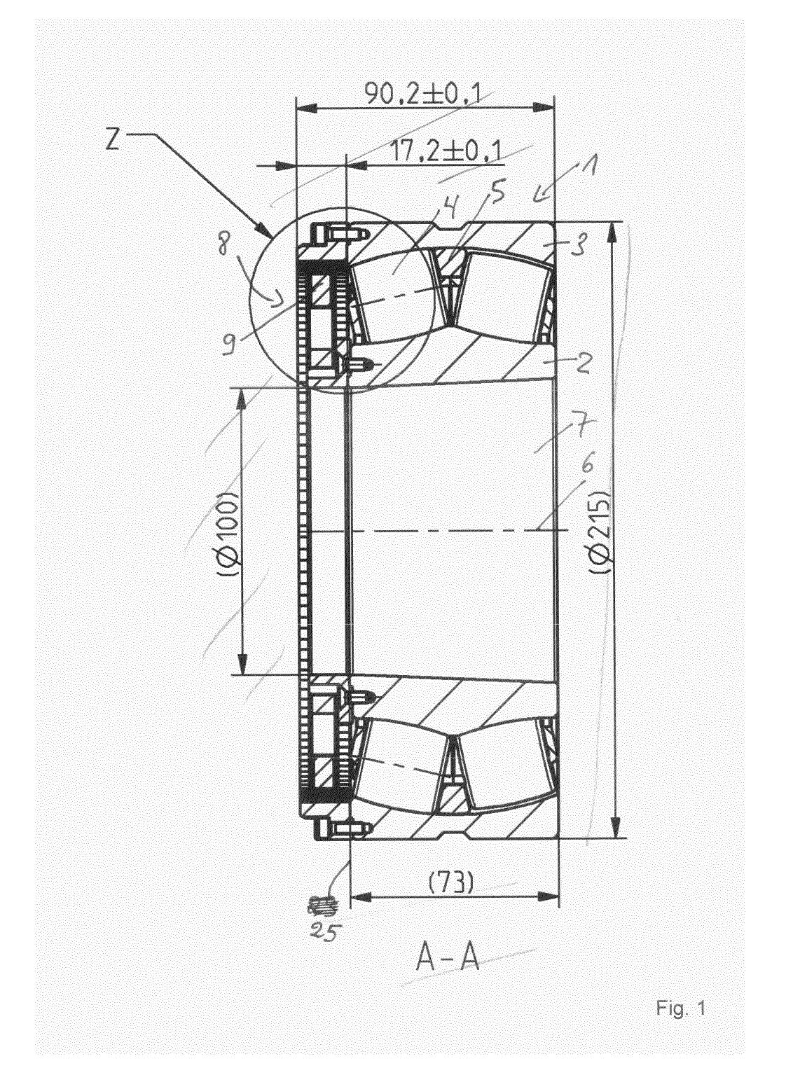

FIG. 1 shows a bearing in the form of a rolling bearing 1 which comprises a first bearing ring 2 and a second bearing ring 3. The rolling bearing 1 is designed to have two rows and comprises two rows of rolling elements 4, which are in the form of self-aligning rollers. The rolling elements 4 are guided by a bearing cage 5 in the circumferential direction, based on an axis of rotation 6 of the rolling bearing 1, and axially, i.e. substantially parallel to the axis of rotation 6 of the rolling bearing 1, and are held spaced apart. The two rows of the self-aligning rollers 4 are arranged offset with respect to one another in the circumferential direction.

The rolling bearing 1 is part of a bearing arrangement for rotatably mounting a roller, namely a guide roller for paper webs of a printing machine, wherein a conically tapering shaft 7 is held rotatably about the axis of rotation 6.

The guide roller has a pressure sensor, which detects the contact pressure of the paper web on the outer lateral surface of the roller, wherein the piezoelectric pressure sensor is provided on the lateral surface so as to encircle said lateral surface in helical fashion as a layer. Energy is supplied to the pressure sensor by the rolling bearing 1. For this, the rolling bearing 1 comprises an energy supply unit 8. The energy supply unit 8 is in the form of claw-pole generator and comprises an induction coil 9 which encircles in the circumferential direction and in particular encircles the axis of rotation 6.

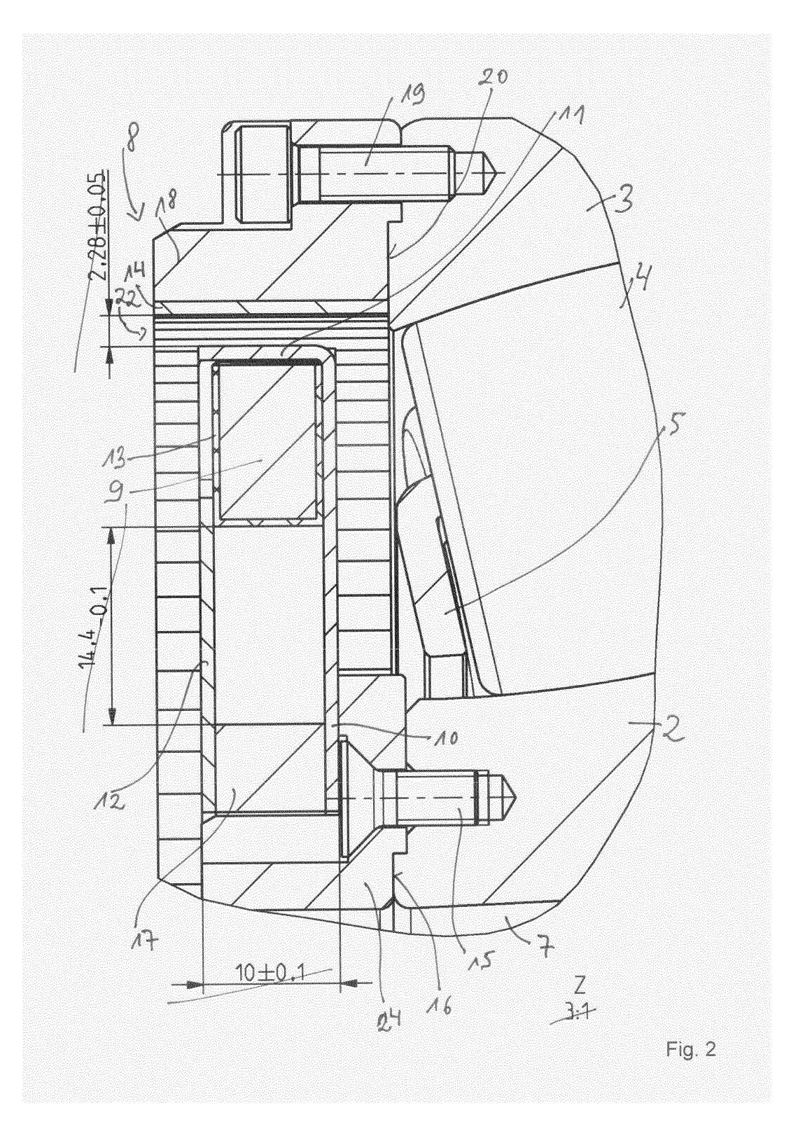

FIG. 2 shows the claw-pole generator 8 in an enlarged illustration.

The claw-pole generator 8 comprises a first claw ring 10, which comprises a series of first claws encircling in the circumferential direction, based on the axis of rotation 6, wherein one of the first claws is denoted by the reference symbol ‘11’. The first claw 11 is in the form of a section of the ring-shaped, radially extending first claw ring 10, which section is positioned substantially axially, i.e. parallel to the axis of rotation 6.

The claw-pole generator 8 comprises a second claw ring 12 with a series of second claws which runs in the circumferential direction, wherein the section plane of the illustration in FIG. 2 is positioned such that a first of the second claws is arranged above the plane of the paper and a second of the second claws, which is adjacent in the circumferential direction, is arranged below the plane of the paper. The section plane of the illustration in FIG. 2 passes through the second claw ring 12 in the region of the radially extending ring-shaped section. The two second claws of the second claw ring 12 (not identified) are, similarly to the first claw 11 of the first claw ring 10, directed axially, i.e. parallel to the axis of rotation 6.

The two claw rings 10, 12 of the claw-pole generator 8 surround the induction coil 9, which is arranged in a receptacle 13, which surrounds the induction coil 9 on three sides, wherein the claws 11 of the claw rings 10, 12 engage over the induction coil 9 on the remaining fourth side of the receptacle 13. The receptacle 13 is formed from a magnetically nonconductive material, namely an injection-moldable plastic, and is in the form of a hollow ring which is open on the inside with a substantially U-shaped cross section, wherein the induction coil 9 is received between the limbs of the U and, on the outside, the respective claw ring 10, 12 rests on the limb of the U on both limbs of the U.

The induction coil denoted by the reference symbol 9 has, in addition to a metallic conductor which surrounds the axis of rotation 6 with a plurality of turns, an electrically conductive casting compound, so that a dimensionally stable composite is produced which can be inserted, as an induction core 9, into the receptacle 13, namely the opening of the U. The claws of the two claw rings 10, 12 cover the opening of the U and prevent the induction coil 9 from falling out of the receptacle 13.

The claw-pole generator further comprises a series of magnetic poles encircling in the circumferential direction, namely the axis of rotation 6, wherein said poles are denoted by the reference symbol 14. Adjacent poles are in this case of different polarity, for example the magnetic pole 14 is a north pole and the respectively adjacent magnetic pole, located above or below the plane of the paper is a south pole. The magnetic poles 14 are in this case sections of plate-shaped permanent magnets which, arranged alternately in the circumferential direction, are aligned in such a way that in each case one pole points in the direction of the axis of rotation 6 and therefore in the direction of a claw of one of the two claw rings 10, 12.

The two claw rings 10, 12 are arranged offset with respect to one another in the circumferential direction such that, for example, all of the first claws 11 of the first claw ring 10 are opposite a north pole 14 and all of the second claws of the second claw ring 12 are opposite a south pole.

Thus, a magnetic circuit encircling the induction coil 9 and the electrically conductive turns accommodated there forms, starting from the first magnetic pole 14 in the form of the north pole, via a gap with respect to the first claw 11 of the first claw ring 10, via the magnetically conductive material of the body of the first bearing ring 2 to the second claw ring 12 with respect to one of the second claws of the second claw ring 12 via the gap with respect to a magnetic pole in the form of a south pole, which is adjacent to the magnetic pole 14 in the form of the north pole in the circumferential direction. As the bearing ring 2 rotates about the axis of rotation, the orientation of the magnetic circuit changes, so that an AC voltage is induced in the turns of the electrical conductor in the induction coil 9, said AC voltage being tapped off as useful voltage, in particular after electronic conditioning.

The two claw rings 10, 12 and the induction coil 9 are fastened on a first carrier ring 24, which is in turn fastened so as to lie flat on a planar end face 16 of the first bearing ring 2 by a first screw 15 so as to form a first screw connection. The first carrier ring 24 is formed from a material with good magnetic conductivity, lies in planar fashion and completely flat on the end face 16 of the first bearing ring 2 and completely encircles the end face 16 of the first bearing ring 2.

The flux-concentrating ring 17, which magnetically conductively connects the two claw rings 10, 12 and is arranged so as to be clamped in-between the two ring-shaped sections of the claw rings 10, 12, is provided between the two claw rings 10, 12.

The magnetic poles, in particular the magnetic pole of the permanent magnet which is illustrated in cross section and is denoted by the reference symbol 14, are fastened on a second carrier ring 18, wherein the second carrier ring 18 is fastened on an end face 20 of the second bearing ring 3 by means of a second screw 19 so as to form a second screw connection. The magnetic poles are magnetically conductively connected to one another by means of a magnetic return path ring; in particular the magnetic pole denoted by the reference symbol 14 is magnetically conductively connected to the magnetic poles of different polarity which are located above or below the plane of the paper and are adjacent in the circumferential direction. The magnetic return path ring is formed integrally with the second carrier ring 18, in particular the second carrier ring 18 is formed from a magnetically conductive material. The second carrier ring 18 rests completely on the end face 20 of the second bearing ring 3 and encircles the axis of rotation as a flat circular ring. Likewise, the first carrier ring 24 is in the form of a flat circular ring, wherein the extent of the two carrier rings 24, 18 in the direction of the axis of rotation 6 (FIG. 1) is shorter than the extent of the rolling elements 4 in this axial direction.

FIG. 2 likewise shows that an extent of the magnetic poles, including the magnetic pole denoted by the reference symbol 14, in the axial direction, i.e. parallel to the axis of rotation 6 (FIG. 1), is greater than the extent of the claws, including the first claw 11 of the first claw ring 10, in the axial direction, in particular that the extent of the magnetic poles 14 in the axial direction is approximately double the extent of the claws 11 in the axial direction. Due to the fact that the bearing 1 is in the form of a self-aligning roller bearing, tilting of the second bearing ring 3 relative to the first bearing ring 2 is possible, with the result that a gap 22 between the claw 11 and the magnetic pole 14, which has a constant gap width in the untilted state of the bearing 1, demonstrates a variable gap width in the tilted state of the bearing 1, to be precise such that the gap width decreases in a narrow region, but overall increases and the claw 11 shifts relative to the magnetic pole 14 in the axial direction. The effective increase in the gap width is compensated for slightly by the overhang of the magnetic pole 14 with respect to the claw 11 in the axial direction, parallel to the axis of rotation 6, and in particular the shift of the claw 11 with respect to the magnetic pole 14 is compensated for slightly by extension of the magnetic pole 14 in the axial direction, with the result that the tilting does not result in substantial weakening or interruption of the magnetic circuit which is formed over the gap 22.

The gap 22 is delimited in the cross-sectional illustration illustrated in FIG. 2 by two substantially cylindrical faces which are concentric with respect to the axis of rotation 6, namely by the claw 11 and by the magnetic pole 14, with the result that the gap 22 runs parallel to the axis of rotation 6 and concentrically thereto. The gap 22 does not enclose an angle with the axis of rotation 6 and does not intersect the axis of rotation 6.

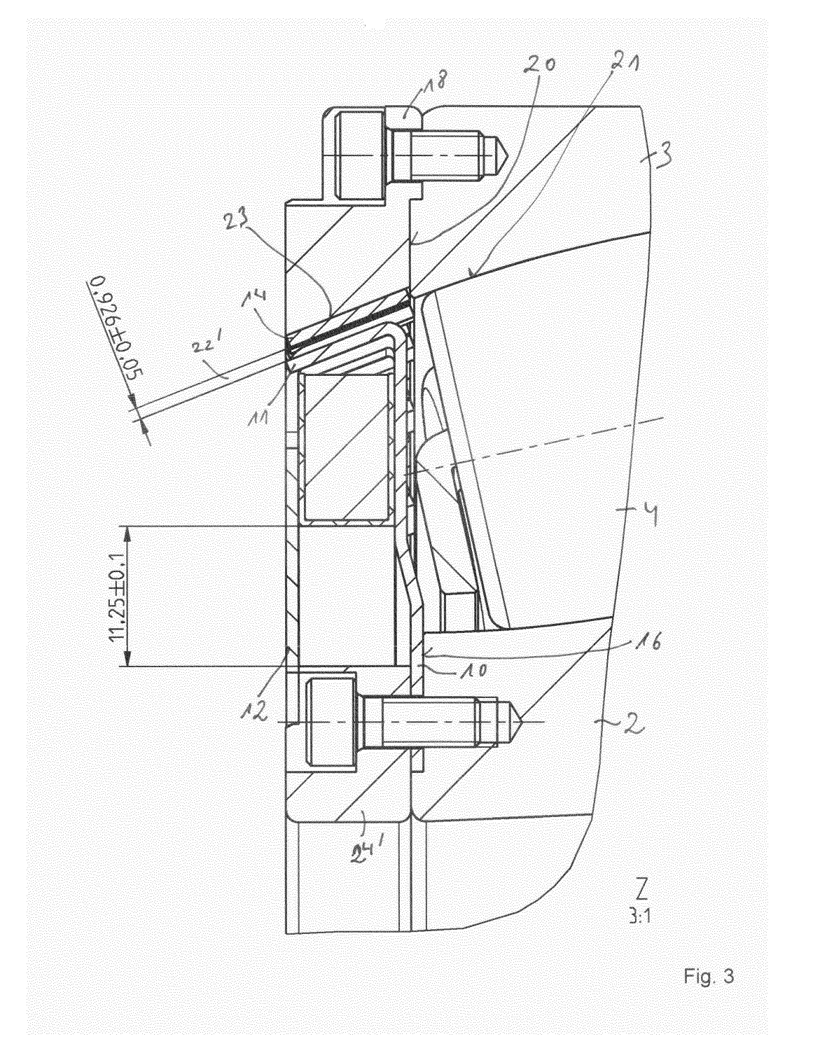

FIG. 3 shows, sectionally, a second exemplary embodiment of a bearing 1, namely a self-aligning roller bearing with two rows, with an energy generation unit in the form of a claw-pole generator. In particular, the differences over the first exemplary embodiment illustrated in FIG. 2 will be set forth below, where identical reference numerals denote identical or comparable, in terms of technical effect features.

FIG. 3 shows a flux-concentrating ring which is formed integrally with the first carrier ring 24′, in particular shows that the first carrier ring 24′ is formed from a magnetically conductive material, with the result that the first carrier ring 24′ magnetically conductively connects the two claw rings 10, 12. The first claw ring 10 rests sectionally directly on the end face 16 of the first bearing ring 2. The magnetic resistance of the first carrier ring 24′ is so low in comparison with that of the first bearing ring 2, however, that leakage losses over the first bearing ring 2, the rolling element 4 and the second bearing ring 3 are negligible and the magnetic circuit is closed substantially by the first carrier ring 24′.

FIG. 3 also shows that the gap 22′ between the claw 11 and the magnetic pole 14 runs at an angle to the axis of rotation 6 (FIG. 1); the gap 22′ is in particular inclined with respect to the axis of rotation 6. In particular, the gap 22′ is no longer delimited by two cylindrical faces. In the illustration in FIG. 3, in a section plane containing the axis of rotation 6, the gap 22′ is formed between the claw 11 and the magnetic pole 14, said gap being delimited by two substantially non-cylindrical faces. In this case, the gap 22′ has a substantially linear profile which is inclined with respect to the axis of rotation 6. The gradient of the straight line in this case corresponds to a tangent to a race 21 of the rolling elements 4 close to the end face 20 of the second bearing ring 3; in this case, the gap 22′ represents an imaginary extension of the race 21, possibly shifted parallel in the radial direction.

The claw 11 and the magnetic pole 14 are arranged inclined based on the axis of rotation 6 (FIG. 1) and each form a conically tapering face, which delimits the gap 22′, wherein the conically tapering faces are formed concentrically. For this, the claw 11 is set at an angle of more than 90°, for example approximately 110°, from the substantially planar radial section of the first claw ring 10. Furthermore, the second carrier ring 18 is configured such that it has a bevel 23, which is opposite the claw 11 and on which the permanent magnet with the magnetic pole 14 is arranged, with the result that the gap 22′ with an approximately constant gap width is produced. The extent of the magnetic pole 14 in the direction of the bevel 23 in this case corresponds to the extent of the claw 11 parallel to the direction of the bevel 23, with the result that, in particular, the magnetic pole 14 does not protrude substantially beyond the claw 11 in the axial direction, parallel to the axis of rotation 6 (FIG. 1).

The angle of inclination of the bevel 23 is selected such that the two faces delimiting the gap 22′ are formed as an imaginary extension of the race 21 of the second bearing ring 3. In particular, the bevel 23 forms the imaginary, in this case linear, extension of a tangent to the cross section of the race 21 close to the end face 20 of the second bearing ring 3. The cross section of the claw 11 is then formed parallel to the extension of the tangent. Thus, the claws of the two claw rings 10, 12 and the magnetic poles form a respectively conically tapering contour.

As a deviation from the above-described, second exemplary embodiment, provision can be made, instead of two conical faces which delimit the gap 22′, for the gap to have a curved profile, in particular a profile which is curved substantially in the form of a segment of a circle. In this case, the gap is delimited substantially by at least one sectionally spherically curved face, in particular by two spherically curved faces. The profile of the gap which is curved in the form of a segment of a circle in a section plane containing the axis of rotation 6 then has a radius of curvature which corresponds to that of the race 21 close to the end face 20 of the second bearing ring 3.

In the two above-described exemplary embodiments, provision has been made in each case for the contact face of the first carrier ring 24 to lie with the end face 16 of the first bearing ring 2 and for the contact face of the second carrier ring 18 to lie with the end face 20 of the second bearing ring 3 in a common imaginary plane 25 (FIG. 1). In this case, the claw-pole generator protrudes only slightly beyond the two end faces 16, 20 of the bearing 1 and is very flat. The race 21 of the rolling elements 4 reaches as far as directly to the claw-pole generator 8, with the result that the bearing rings 2, 3 of the bearing 1 do not require any additional installation space in the axial direction, parallel to the axis of rotation 1, in order to be able to receive the claw-pole generator 8.

In the above-described exemplary embodiments, provision has been made in each case for the claw rings 10, 12 and the induction coil to be fastened on the first bearing ring 2, which rotates with the shaft 7, and for the magnetic poles 14 to be fastened, fixed against rotation, on the stationary second bearing ring 3. It goes without saying that the magnetic poles 14 can also be fastened on the rotating bearing ring, i.e. on the first bearing, ring 2 in both of the above exemplary embodiments, and the unit comprising the claw rings 10, 12 and the induction coil 9 can be fastened on the fixed bearing ring 3.

In both of the above-described exemplary embodiments, the bearing 1 has in each case been in the form of a rolling bearing, namely a self-aligning roller bearing with two rows of rolling elements 4. It goes without saying that the rolling bearing can also have other rollers than rolling elements, for example tapered rollers or cylindrical rollers. The rolling bearing can in particular be in the form of a ball bearing with one or more rows, in particular in the form of an angular contact ball bearing. In addition, it goes without saying that the bearing can also be in the form of a plain bearing, in particular a spherical plain bearing.

In both of the exemplary embodiments described above, the magnetic return path ring which magnetically conductively connects the magnetic poles 14 of the permanent magnet to one another has been formed integrally with the second carrier ring 18 and has been in the form of a magnetically conductive section of the second carrier ring 18. In this case, the second carrier ring 18 consisted completely of a magnetically conductive material. It goes without saying that a magnetic return path ring consisting of a magnetically conductive material can be provided in addition to the second carrier ring 18 and can be fastened on the second carrier ring 18, in particular when the bores for receiving the second screw 19 or receiving apparatuses for other fastening means sectionally interrupt the magnetic conductivity of the second carrier ring 18 and can become inhomogeneous. The magnetic return path ring can be in the form of a strip of material with good magnetic conductivity, in particular of a rolling bearing steel, of iron or a ferromagnetic steel, which is embedded in that part of the second carrier ring 18 which points towards the claws 11.

In addition to the two above-described embodiments, a holding ring can also be provided, in which the permanent magnets with the magnetic poles 14 are inserted and are arranged so as to be fixed in the circumferential direction of the second carrier ring 18, wherein the holding ring can be formed from a magnetically nonconductive material such as brass.

### LIST OF REFERENCE SYMBOLS

1 Rolling bearing

2 First bearing ring

3 Second bearing ring

4 Rolling element

5 Bearing cage

6 Axis of rotation

7 Shaft

8 Energy generation unit

9 Induction coil

10 First claw ring

11 First claw

12 Second claw ring

13 Receptacle

14 Magnetic pole

15 First screw

16 End face of first bearing ring 2

17 Flux-concentrating ring

18 Second carrier ring

19 Second screw

20 End face of second bearing ring 3

21 Race

22, 22′ Gap

23 Bevel

24, 24′ First carrier ring

25 Plane

1. A bearing comprising:
a first bearing ring,
a second bearing ring, and
an energy generation unit comprising a claw-pole generator, the claw-pole generator comprises a first claw ring with a series of first claws and a second claw ring with a series of second claws, said second claw ring is offset in a revolving direction of an axis of rotation, the two claw rings surround an induction coil encircling the axis of rotation,
the claws of the two claw rings include a series of magnetic poles which encircle the axis of rotation and form magnetic circuits surrounding the induction coil,
the claw rings and the induction coil are fastened with a first carrier ring on an end face of the first bearing ring,
the magnetic poles are fastened on an end face of the second bearing ring by a second carrier ring,
the magnetic poles are magnetically conductively connected to one another by a magnetic return path ring formed of a magnetically conductive material, and
the two claw rings are magnetically conductively connected by a flux-concentrating ring.

2. The bearing as claimed in claim 1, wherein a gap is formed between the claws and the magnetic poles, said gap being inclined towards the axis of rotation.

3. The bearing as claimed in claim 2, wherein the gap has a substantially linear profile.

4. The bearing as claimed in claim 2, wherein the gap has a curved profile.

5. The bearing as claimed in claim 2, wherein the gap is delimited by faces, and one of the faces delimiting the gap is formed as an imaginary extension of a race of one of the bearing rings.

6. The bearing as claimed in claim 2, wherein the bearing is a self-aligning roller bearing or spherical plain bearing.

7. The bearing as claimed in claim 1, wherein the magnetic return path ring is formed integrally with the second carrier ring.

8. The bearing as claimed in claim 1, wherein an extent of the magnetic poles in the axial direction is greater than an extent of the claws in the axial direction.

9. The bearing as claimed in claim 1, wherein the flux-concentrating ring is formed integrally with the first carrier ring.

10. The bearing as claimed in claim 1, wherein at least one of the carrier rings is fastened on an end face of the bearing ring by a screw connection.

11. A bearing arrangement for rotatably mounting a roller, comprising a bearing as claimed in claim 1.

12. The bearing arrangement as claimed in claim 11, further comprising a pressure sensor on a lateral surface of the roller, and energy is supplied to the pressure sensor by the energy generation unit of the rolling bearing.

13. The bearing arrangement as claims in claim 12, wherein the pressure sensor is a piezoelectric pressure sensor.

14. The bearing as claimed in claim 7, wherein the second carrier ring is formed from a magnetically conductive material.

15. The bearing as claim in claim 8, wherein the extent of the magnetic poles in the axial direction is approximately double the extent of the claws in the axial direction.

16. The bearing as claims in claim 9, wherein the first carrier ring is formed from a magnetically conductive material.
